(19) United States
(12) Patent Application Publication
(10) Pub. No.: US 2010/0199845 A1
(43) Pub. Date: Aug. 12, 2010

(54) APPLIANCE FOR DISPENSING A BEVERAGE

(75) Inventors: Sandra aus der Fuenten, Bielefeld (DE); Gerald Aengenheyster, Minden (DE); Nils Krutemeyer, Kirchlengern (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 12/700,534

(22) Filed: Feb. 4, 2010

(30) Foreign Application Priority Data
Feb. 6, 2009 (DE) 20 2009 001 492.4

(51) Int. Cl. B67D 1/00

(52) U.S. Cl. 99/275

(57) ABSTRACT

An appliance for dispensing a beverage includes a housing, an outlet for dispensing a prepared beverage disposed on one side of the housing, a first support arranged below the outlet onto which a container can be placed for filling, and at least one second support securable on the housing above the first support. The second support is mounted so that it is displaceable along a horizontal plane into an opening on the one side of the housing.

### CROSS-REFERENCE TO RELATED APPLICATION

This application claims the priority of German Patent Application No. DE 20 2009 001 492.4, filed on Feb. 6, 2009, the subject matter of which is incorporated herein by reference.

### BACKGROUND OF THE INVENTION

The present invention relates to an appliance for dispensing a beverage, in particular to an automatic coffee machine, comprising a housing provided with an outlet on one side for dispensing a prepared beverage and a first support arranged underneath the outlet onto which a container to be filled is placed.

The European patent document EP 1 745 726 discloses an automatic coffee machine with a discharge unit that can be adjusted in height by moving it vertically up and down on a housing with the aid of a guide. A vertical positioning in dependence on the size of a container arranged below the discharge unit is thus possible while a cup support is fixedly mounted on the housing. To be sure, the discharge unit can be adjusted in height, but this adjustment requires a bendable feed tube leading to the discharge unit. A relative large structural expenditure is therefore required because of the plurality of tubes involved, in particular when arranging several different lines on a discharge unit. The vertical guide can furthermore easily jam and is hard to handle.

European patent document EP 1 639 926 discloses a vertical adjustment of the collecting basin which requires an adjustment mechanism with a vertically extending toothed rack to which the collecting basin can be attached. The problem with the vertical adjustment of the collecting basin, however, is that it can jam easily and that the adjustment operation is viewed as cumbersome by the user. In addition, the adjustment appliance with numerous individual components is rather complex and expensive to produce.

### SUMMARY OF THE INVENTION

It is therefore an object of the present invention to provide an appliance for dispensing a beverage which avoids the aforementioned disadvantages according to the prior art and permits an easy adaptation to different container sizes.

The above and other objects are accomplished according to the invention, wherein, according to one embodiment, there is provided an appliance for dispensing a beverage, comprising: a housing; an outlet for dispensing a prepared beverage disposed on one side of the housing; a first support arranged below the outlet onto which a container can be placed for filling; and at least one second support securable on the housing above the first support, the second support being mounted so that it is displaceable along a horizontal plane into an opening on the one side of the housing.

Therefore, according to the invention, the appliance includes a first support arranged underneath an outlet for dispensing beverages. Above this first support, at least one second support is provided which can be secured on the housing, so that depending on the size of a container to be filled, either the first or the second support can be used for positioning the container. The second support can be secured on the housing so that an involved repositioning of the outlet or the first cup support can be omitted. In addition, no involved structure must be provided on the first support to install the second support.

The second support may be inserted or pushed into an opening in the housing. As a result of inserting it, the second support can be installed easily on the housing because it may be secured by press-fit inside the opening. The second support can be pushed into the opening so that it is hidden inside the housing when not in use, thereby making it easy to handle for the user who does not have to worry about storage of the second support.

The second support may be arranged so as to move along a horizontal guide. The horizontal guide can be formed by u-shaped rails which accommodate the support on opposite sides, such that support can be displaced, thereby avoiding the use of expensive rolling bearings. In place of a horizontal linear guide, the second support can also be mounted such that it can pivot into the housing, for which only a corresponding pivoting or rotating bearing must be provided on the housing. For example, the second support may be pivoted about a vertical axis to move in a horizontal plane into the opening in the housing.

For a compact configuration, the second support in the pivoted-in position may be locked into place inside the housing. The second support can be pre-tensioned for a pivoted-out position with the aid of a spring, such that the second support is easy to handle and automatically moves via the spring force into the pivoted-out position. The second support can either be moved mechanically with the aid of a spring, or it can also be moved with the aid of a drive. Mechanical mechanisms may be used for the locking operation which require that the locking mechanism is unlocked by activating a switch or by pushing in the second support, so that the second support moves out of the housing. The spring may be tensioned again during the manual insertion of the support, wherein the support is again locked into position when in the inserted position.

According to a further embodiment of the invention, the second support may be smaller than the first support, for example by more than 50%. As a result, a user is visually shown that only smaller containers with a lower volume should be placed onto the second support for filling.

To avoid an overflowing of liquid on the second support, at least one discharge opening may be provided in the second support to allow liquid coming from the outlet to flow directly onto the first support and from there into an underneath-arranged collecting basin.

In addition, a third support may be arranged below the outlet and above the first support, so that the adjustment height can be sub-divided even further.

### BRIEF DESCRIPTION OF THE DRAWINGS

These and other features and advantages of the invention will be further understood from the following detailed description of embodiments of the invention with reference to the accompanying drawings.

FIG. 1 is a perspective view of an appliance according an embodiment of the invention.

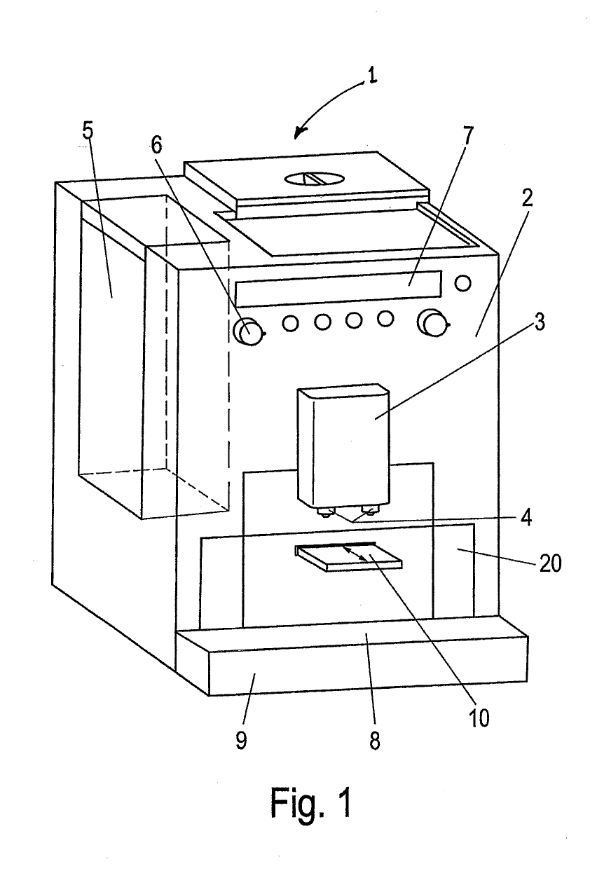

FIG. 2 is an perspective view of components of the region of the second support of the appliance shown in FIG. 1.

FIG. 3 is a view from the side of the second support in the moved-out position.

FIG. 4 is a view from the side of the second support in the moved-in position.

### DETAILED DESCRIPTION OF THE PREFERRED EMBODIMENTS

Referring to the figures, there is shown an appliance 1 for dispensing a beverage, in particular an automatic coffee machine. The appliance includes a housing 2 with an outlet 3 arranged on a front side. Two beverage dispensing tubes 4 are provided on the outlet 3, wherein it is also possible to provide additional dispensing tubes on the outlet 3.

The appliance 1 furthermore comprises a water reservoir 5 and a coffee brewing unit which is arranged inside the housing 2. The brewing operation is automatic, wherein the user can select various programs for the beverage preparation via a switch 6 and a display 7 and, in particular, can also control a metering of the amounts.

To fill the beverages prepared inside the appliance into containers, the housing 2 contains a collecting basin 9 in the bottom which projects over the front and on which a first support 8 for a container is arranged. The first support 8 can be provided with openings for the liquid to flow into the collecting basin 9.

The first support 8 is positioned relatively far from the outlet 3, so that larger containers can be placed thereon. When smaller containers are placed onto the first support 8, the prepared beverage could splatter during the filling operation and result in dirtying the appliance. To avoid to a situation, a second support 10 is arranged above the first support 8 and below the outlet 3. The second support 10 is attached to a housing section 20 on the front of the housing 2.

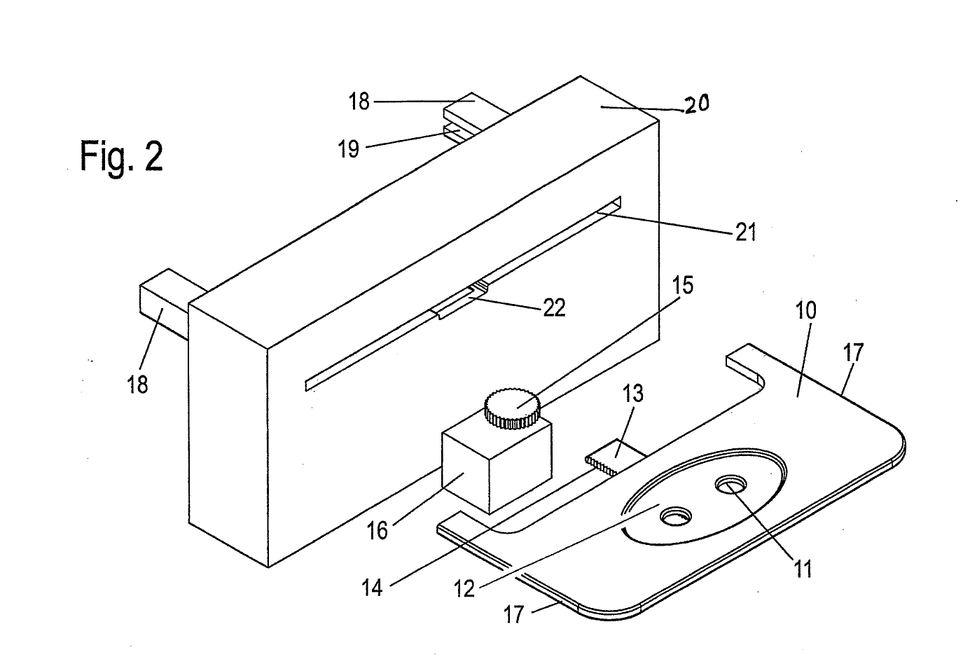

As shown in FIG. 2, the housing section 20 comprises a slot-shaped horizontal opening 21 with a recess 22 in the center. The second support 10 is plate-shaped and can be inserted into the slot 21 in the housing section 20. The second support 10 is provided with a recessed area 12 with two openings 11. If the second support is pivoted out, these openings 11 are positioned underneath the two dispensing tubes 4, so that in case of an accidental dispensing of a beverage without a container present on the second support 10, the liquid can flow through the second support 10 and the first support 8 and into the collecting basin.

Respectively one u-shaped rail 18 is arranged on opposite sides inside the housing section 20 for guiding the second support 10. On the side facing toward the inside, this rail forms a groove 19. An edge section 17 of the second support 10 is held inside the groove 19.

In order to move the second support 10, a drive 16 is provided that uses a drive wheel 15 for driving a rack 13 with toothing 14. The rack 13 is affixed to the underside of the second support 10.

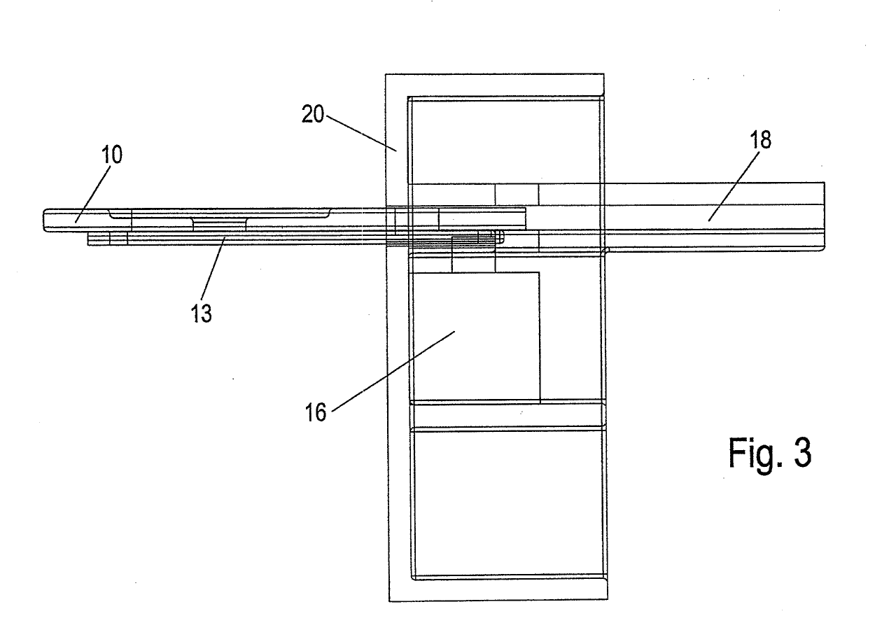

FIG. 3 shows the second support 10 in the moved-out position in which the support 10 projects from the housing section 20, wherein only a small portion of the second support 10 is held inside the horizontal guide 18.

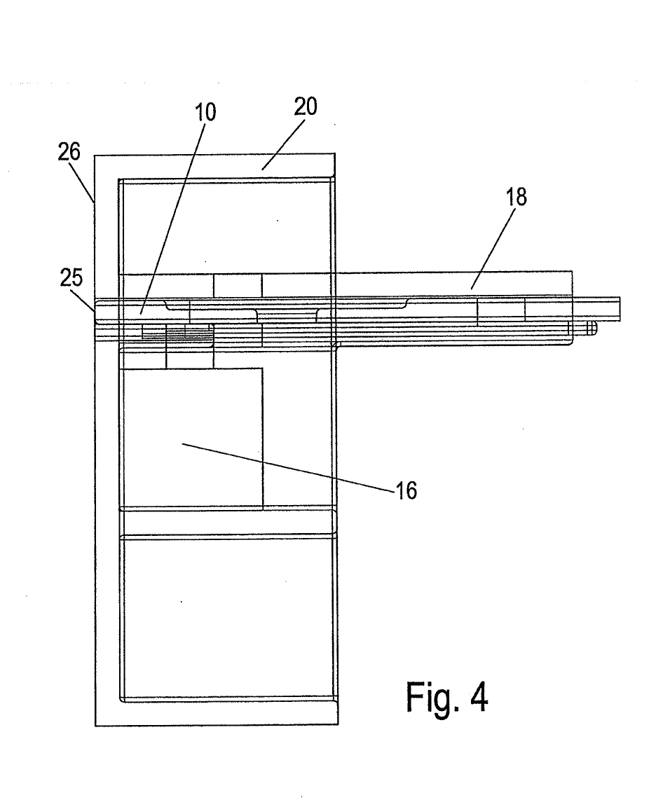

For the embodiment shown in FIG. 4, the second support 10 is moved into the housing section 20. The drive 16 in this case has moved the second support 10 into the housing section 20 via the drive wheel 15 and the rack 13 with toothing 14. A front edge 25 of the second support 10 fits flush with a front 26 of the housing section 20, thus providing the optical illusion of a closed appearance.

For the embodiment shown herein, the second support 10 can be moved with the aid of a motor. The motor is activated via a control (not shown) for the appliance 1, wherein sensors (not shown) can also be provided for detecting an obstacle during the moving out of the second support 10, so as to avoid pushing over a container or to avoid other accidents during the moving out of the second support 10. In place of a motorized drive, the second support 10 can also be stored mechanically, in particular with the aid of a spring (not shown) which pre-tensions the second support 10 in the moved out position. A locking mechanism (not shown) may be provided for locking the second support 10 in place inside the housing section 20 when it is in the pivoted-in position. The second support 10 can be unlocked and moved with the aid of the spring force to the pivoted-out position by depressing the second support, pushing an unlocking switch, or activating an automatic unlocking appliance. The spring is subsequently tensioned once more during the manual insertion of the second support 10.

For the embodiment shown herein, the second support is provided between the outlet 3 and the first support 8. Of course, it is also possible to provide a third support (not shown) as well as additional supports on the housing section 20 to permit a better height adjustment.

It will be understood that the above description of the present invention is susceptible to various modifications, changes and adaptations, and the same are intended to be comprehended within the meaning and range of equivalents of the appended claims.

What is claimed is:

1. An appliance for dispensing a beverage, comprising:
a housing;
an outlet for dispensing a prepared beverage disposed on one side of the housing;
a first support arranged below the outlet onto which a container can be placed for filling; and
at least one second support securable on the housing above the first support, the second support being mounted so that it is displaceable along a horizontal plane into an opening on the one side of the housing.

2. The appliance according to claim 1, further including a horizontal guide arranged to guide the second support for movement in the horizontal plane.

3. The appliance according to claim 1, wherein the second support is arranged to be manually pushed into the opening in the housing.

4. The appliance according to claim 1, wherein the second support is mounted to be pivoted into the opening in the housing.

5. The appliance according to claim 1, further including a locking mechanism to lock the second support in place inside the housing subsequent to being displaced into the opening in the housing.

6. The appliance according to claim 1, further including a spring arranged to pre-tension the second support to be in a position displaced away from the housing.

7. The appliance according to claim 1, further including a drive arranged inside the housing and couple to move the second support.

8. The appliance according to claim 1, wherein the second support is smaller than the first support.

9. The appliance according to claim 1, wherein the second support is smaller than the first support by at least 501.

10. The appliance according to claim 1, wherein the second support includes at least one discharge opening.

11. The appliance according to claim 1, further including a third support.
